(19) United States
(12) Patent Application Publication
(10) Pub. No.: US 2004/0018138 A1
(43) Pub. Date: Jan. 29, 2004

(54) Carbonaceous material, hydrogenoccluding material, hydrogen-occluding apparatus, fuel cell, and method of hydrogen occlusion

(75) Inventor: Tatsushiro Hirata, Kanagawa (JP)

Correspondence Address: Randy J. Pritzker, Wolf, Greenfield & Sacks, P.C., 600 Atlantic Avenue, Boston, MA, 02210, US

(73) Assignee: Sony Corporation, Tokyo (JP)

(21) Appl. No.: 10/320,337

(22) Filed: Dec. 16, 2002

(30) Foreign Application Priority Data
Dec. 14, 2001 (JP) JP2001-380898
Aug. 14, 2002 (JP) JP2002-174001

(51) Int. Cl. H01M 4/96

(52) U.S. Cl. 423/447.2; 429/44

(57) ABSTRACT

The present invention relates to a carbonaceous material including a cylindrical carbonaceous molecule; and an atom or atomic group introduced thereinto, wherein a chemical potential of a hydrogen molecule near the cylindrical carbonaceous molecule introduced the atom or atomic group thereinto is lower than a chemical potential of another hydrogen molecule near a cylindrical carbonaceous molecule which is not introduced the atom or atomic group thereinto, the position of the latter hydrogen molecule being equivalent to that of the former hydrogen molecule to the cylindrical carbonaceous molecule. With this configuration, it is possible to realize greatly improved hydrogen-occluding performance (or capability of occluding a large amount of hydrogen under normal pressure).

### BACKGROUND OF THE INVENTION

The present invention relates to a carbonaceous material, hydrogen-occluding material, hydrogen-occluding apparatus, fuel cell, and method of hydrogen occlusion, which are favorably applied to the energy system that employs hydrogen energy.

Since the Industrial Revolution, fossil fuel such as gasoline and light oil has been widely used as an energy source for automobiles and electric power generation. With the help of fossil fuel, the humankind greatly improved their living standard and developed various industries. On the other hand, the consumption of fossil fuel has led to serious environmental disruption on the global scale. Now, it is feared that fossil fuel will be exhausted in near future, and the long-term stable supply of fossil fuel seems uncertain.

Under these circumstances, hydrogen as a substitute for fossil fuel has come to draw keen attention by virtue of its outstanding merits (for example, inexhaustible supply from water ubiquitous on the earth, large amount of chemical energy per unit weight, and freedom from emission of harmful substance and global warming gases after energy generation). It is expected to be a clean inexhaustible energy source.

Nowadays, active research and development works are being carried out on the fuel cell which converts hydrogen energy into electric energy. The fuel cell is expected to find use as large-scale power plants, on-site domestic power generators, and automotive power source.

Unfortunately, hydrogen is more difficult to handle than liquids and solids because it is in the gaseous state at normal temperature under normal pressure. Moreover, hydrogen in the gaseous state has a much lower density than liquids and solids and hence has a very small chemical energy per unit volume. It presents difficulties in storage and transportation. It easily leaks to bring a danger of explosion. These problems prevent the general use of hydrogen energy.

For a hydrogen-based practical energy system, technological innovations are being made to store gaseous hydrogen in a small volume safely and efficiently. Several methods have been proposed for storage in the form of compressed gas or liquefied gas or for storage by occlusion in a special material.

Storage in the form of compressed gas needs very strong pressure-resistant metal containers such as steel bottles. The disadvantage of this storage method is that metal containers are very heavy and the hydrogen storage density is normally 12 mg/cc or so. This low storage density means low storage efficiency. In addition, compressed hydrogen under high pressure poses problems with safety.

By contrast, in storage in the form of liquefied hydrogen, the hydrogen storage density is normally 70 mg/cc or so. The advantage of this high storage density is offset by the necessity of cooling hydrogen below −250° C. for liquefaction. Cooling needs additional equipment and energy, which makes the system more complex.

Storage by occlusion is achieved by the help of a hydrogen-occluding material. In the hydrogen-occluding material, a hydrogen-occluding alloy is a most effective material, such as tantalum-nickel-based alloy, vanadium-based alloy, and magnesium-based alloy. Hydrogen storage density in these alloys is about 100 mg/cc, normally. This density is higher than that of liquefied hydrogen even though hydrogen exists in a foreign substance. Therefore, occlusion is the most efficient among the related-art ways to store hydrogen. In addition, occlusion in the above-mentioned alloys can be accomplished at room temperature level and occluded hydrogen can be released from those alloys. Occluded hydrogen is easier to handle than compressed hydrogen and liquefied hydrogen because the hydrogen occlusion state is controlled in equilibrium with hydrogen partial pressure.

Notwithstanding, hydrogen-occluding alloys consisting of metal alloys are so heavy that they occlude only 20 mg or so of hydrogen per gram. This amount is far from satisfactory. Moreover, in the hydrogen-occluding alloys, their structures gradually decay to deteriorate in their performance after repeated occlusion and release of hydrogen gas. Alloys of certain composition possibly pose resource and environmental problems.

Carbonaceous materials are now attracting attention as the promising hydrogen-occluding materials which would solve problems involved with related-art hydrogen storage methods. They are under study from every angle.

For example, Japanese Patent Laid-open No. Hei 5-270801 discloses a method for occlusion of hydrogen by addition reaction of hydrogen on fullerene. What this method does is addition rather than occlusion because the addition reaction forms chemical bonding like covalent bonding between carbon atoms and hydrogen atoms. The amount of hydrogen that can be added by chemical bonding is limited basically by the number of unsaturated bonds possessed by carbon atoms. Therefore, the amount of hydrogen occlusion in this manner has a limit.

A method of occlusion of hydrogen in fullerene as a hydrogen-occluding material is disclosed in Japanese Patent Laid-open No. Hei 10-72291. This method employs fullerene whose surface is coated with a catalyst metal (such as platinum) by vacuum deposition or sputtering. However, platinum coating on the fullerene surface leads to a high production cost and wastes a valuable resource.

Another promising hydrogen-occluding material that is attracting attention is a carbon nanotube, which is a carbon allotrope consisting of graphene (monolayer graphite) in a fine cylindrical form, 0.5 to 10 nm in diameter and a few micrometers long. This material, however, only occludes under pressure at low temperatures. For this reason, there has been a need for development of a new carbonaceous material capable of occluding a large amount of hydrogen under normal pressure.

### SUMMARY OF THE INVENTION

The present invention was completed to tackle the above-mentioned problem. Thus, it is an object of the present invention to provide a carbonaceous material with greatly improved hydrogen-occluding performance (or capability of occluding a large amount of hydrogen under normal pressure), a hydrogen-occluding material based on the carbonaceous material, a hydrogen-occluding apparatus, a fuel cell, and a method of hydrogen occlusion.

According to a first aspect of the present invention, there is provided a carbonaceous material comprising a cylindrical carbonaceous molecule; and an atom or atomic group introduced thereinto, wherein a chemical potential of a hydrogen molecule near the cylindrical carbonaceous molecule introduced the atom or atomic group thereinto is lower than a chemical potential of another hydrogen molecule near a cylindrical carbonaceous molecule which is not introduced the atom or atomic group thereinto, the position of the latter hydrogen molecule being equivalent to that of the former hydrogen molecule to the cylindrical carbonaceous molecule.

According to a second aspect of the present invention, there is provided a hydrogen-occluding material containing a carbonaceous material, the carbonaceous material comprising a cylindrical carbonaceous molecule; and an atom or atomic group introduced thereinto, wherein a chemical potential of a hydrogen molecule near the cylindrical carbonaceous molecule introduced the atom or atomic group thereinto is lower than a chemical potential of another hydrogen molecule near a cylindrical carbonaceous molecule which is not introduced the atom or atomic group thereinto, the position of the latter hydrogen molecule being equivalent to that of the former hydrogen molecule to the cylindrical carbonaceous molecule.

According to a third aspect of the present invention, there is provided a hydrogen-occluding apparatus having a pressure container and a hydrogen-occluding material held therein, the hydrogen-occluding material containing a carbonaceous material, the carbonaceous material comprising a cylindrical carbonaceous molecule; and an atom or atomic group introduced thereinto, wherein a chemical potential of a hydrogen molecule near the cylindrical carbonaceous molecule introduced the atom or atomic group thereinto is lower than a chemical potential of another hydrogen molecule near a cylindrical carbonaceous molecule which is not introduced the atom or atomic group thereinto, the position of the latter hydrogen molecule being equivalent to that of the former hydrogen molecule to the cylindrical carbonaceous molecule.

According to a fourth aspect of the present invention, there is provided a fuel cell which employs a hydrogen-occluding material, the hydrogen-occluding material containing a carbonaceous material, the carbonaceous material comprising a cylindrical carbonaceous molecule; and an atom or atomic group introduced thereinto, wherein a chemical potential of a hydrogen molecule near the cylindrical carbonaceous molecule introduced the atom or atomic group thereinto is lower than a chemical potential of another hydrogen molecule near a cylindrical carbonaceous molecule which is not introduced the atom or atomic group thereinto, the position of the latter hydrogen molecule being equivalent to that of the former hydrogen molecule to the cylindrical carbonaceous molecule.

In the above-mentioned first to fourth aspects of the present invention, the cylindrical carbonaceous molecule denotes a carbonaceous material typified by a carbon nanotube in which the graphene structure takes on a partly closed cylindrical form. However, it is not limited to a carbon nanotube but it also includes variations thereof, regardless of whether one end of the cylinder is closed or not. In what follows, the cylindrical carbonaceous molecule will be referred to as a carbon nanotube for convenience' sake. A carbon nanotube falls under two large categories, single-wall nanotube and multi-wall nanotube. Both will be used in the present invention.

According to the present invention, the cylindrical carbonaceous molecule (or carbon nanotube) has specific atoms or atomic groups introduced thereinto. Basically, such atoms or atomic groups may be introduced into the outer or inner surface of the cylindrical carbonaceous molecule (or carbon nanotube). Usually, they are introduced into the outer surface, preferably into part of the outer surface, such that the region with the atoms or atomic groups divides the region without the atoms or atomic groups into a plurality of sections. To be concrete, the atoms or atomic groups are introduced in a strip-like manner on the surface of the cylindrical carbonaceous molecule (or carbon nanotube). The strip-like regions form a cylindrical structure or spiral structure. The atoms or atomic groups are one or more species selected from a group consisting of fluorine atoms, hydrogen atoms, and sodium atoms.

The hydrogen-occluding material may contain any other materials than the cylindrical carbonaceous molecule (or carbon nanotube). However, it typically consists entirely of carbon nanotube.

According to a fifth aspect of the present invention, there is provided a hydrogen-occluding material comprising a cylindrical carbonaceous molecule into which at least one fluorine atom is introduced.

According to a sixth aspect of the present invention, there is provided a hydrogen-occluding apparatus having a pressure container and a hydrogen-occluding material held therein, the hydrogen-occluding material containing a cylindrical carbonaceous molecule having at least one fluorine atom introduced thereinto.

According to a seventh aspect of the present invention, there is provided a fuel cell which employs a hydrogen-occluding material, the hydrogen-occluding material containing a cylindrical carbonaceous molecule having at least one fluorine atom introduced thereinto.

According to an eighth aspect of the present invention, there is provided a method of hydrogen occlusion, comprising the steps of: supplying hydrogen to a carbonaceous material containing a cylindrical carbonaceous molecule having at least one fluorine atom introduced thereinto; and changing pressure and/or temperature.

It is apparent from the equation (1) given later that it is possible to control the amount of hydrogen adsorbed by changing the pressure and/or temperature.

What is mentioned above in relation to the first to fourth aspects of the present invention is applicable also to the fifth to eighth aspects of the present invention unless it is contrary to the scope of the present invention.

In the present invention, the cylindrical carbonaceous molecule (or carbon nanotube) having specific atoms or atomic groups introduced thereinto can be produced by heating the cylindrical carbonaceous molecule (or carbon nanotube) in a gaseous atmosphere containing the atoms or atomic groups so that the atoms or atomic groups bond to the carbonaceous material. To be concrete, the carbonaceous material having fluorine atoms introduced thereinto can be obtained by heating the carbonaceous material at 150 to 600° C. or so in an atmosphere of fluorine gas so that fluorine atoms bond to the carbonaceous material.

According to the present invention mentioned above, the chemical potential of hydrogen molecules present in the vicinity of the cylindrical carbonaceous molecule into which the atoms or atomic groups have been introduced is lower than that of hydrogen molecules present in the vicinity of the cylindrical carbonaceous molecule into which the atoms or atomic groups have not yet been introduced, with the position of hydrogen molecules mentioned first being equivalent to that of hydrogen molecules mentioned second. Consequently, the carbonaceous material having the specific atoms or atomic groups introduced thereinto can adsorb more hydrogen molecules than the carbonaceous material not having the specific atoms or atomic groups introduced thereinto, in proportion to the difference between the two chemical potentials.

### BRIEF DESCRIPTION OF THE DRAWINGS

FIG. 1 is a schematic conceptual diagram showing a carbon nanotube derivative composed of a carbon nanotube and atoms or atomic groups added thereto;

FIG. 2 is a schematic diagram showing the relation between exp (−Δμ/kT) and temperature;

FIG. 3 is a longitudinal sectional view showing a hydrogen-occluding apparatus according to Example 2 of the present invention;

FIG. 4 is a schematic diagram showing a model used to calculate the hydrogen adsorption energy of fluorinated carbon nanotube;

FIG. 5 is a schematic diagram showing the relation between the hydrogen adsorption energy of SWNT (12,0) and the distance from the center of carbon nanotube;

FIG. 6 is a schematic diagram showing a ball-and-stick model of the most stable structure of F-SWNT (12,0), CFₓ (x=0.25), having fluorine atoms arranged in a strip pattern;

FIG. 7 is a schematic diagram showing a space-filling model of the most stable structure of F-SWNT (12,0), CFₓ (x=0.25), having fluorine atoms arranged in a strip pattern;

FIGS. 8A and 8B are schematic diagrams showing a ball-and-stick model of the adsorbing site for hydrogen molecules in F-SWNT (12,0), CFₓ (x=0.25);

FIG. 9 is a schematic diagram showing the relation between the hydrogen adsorption energy of F-SWNT (12,0), CFₓ (x=0.25), and the distance from the center of carbon nanotube;

FIG. 10 is a schematic diagram showing a ball-and-stick model of the most stable structure of F-SWNT (12,0), CFₓ (x=0.25), having fluorine atoms arranged in a spiral pattern;

FIG. 11 is a schematic diagram showing a ball-and-stick model of the most stable structure of F-SWNT (12,0), CFₓ (x=0.125), having fluorine atoms arranged in a strip pattern;

FIG. 12 is a schematic diagram showing a space-filling model of the most stable structure of F-SWNT (12,0), CFₓ (x=0.125), having fluorine atoms arranged in a strip pattern;

FIG. 13 is a schematic diagram showing a ball-and-stick model of the adsorbing site for hydrogen molecules in F-SWNT (12,0), CFₓ (x=0.125);

FIG. 14 is a schematic diagram showing the relation between the hydrogen adsorption energy of F-SWNT (12,0), CFₓ (x=0.125), and the distance from the center of carbon nanotube;

FIGS. 15A and 15B are schematic diagrams showing a structure of F-SWNT useful for adsorption of hydrogen;

FIG. 16 is a schematic diagram illustrating the method for interference exposure; and

FIG. 17 is a schematic diagram illustrating the method for preparing F-SWNT by interference exposure.

### DETAILED DESCRIPTION OF THE PREFERRED EMBODIMENTS

The invention will be described in more detail with reference to the following examples.

### EXAMPLE 1

It is known that the chemical potential of gas molecules usually changes in the vicinity of an adsorbent on account of interaction between the gas molecules and the adsorbent, and that the lower the chemical potential, the higher the concentration of gas molecules.

In the case where the gas molecules are hydrogen molecules, the concentration of hydrogen molecules is represented by the following equation (1).

N/V={P* exp(−Δμ/kT)}/kT (1)

where N denotes the number of hydrogen molecules, V denotes the volume of gas, P denotes the pressure of atmosphere, T denotes the temperature (K) of atmosphere, k denotes the Boltzmann constant, and Δμ is defined as Δμ=μ1−μ2 (where μ1 is the chemical potential of hydrogen molecules near the adsorbent and μ2 is the chemical potential of hydrogen molecules far away from the adsorbent).

It is obvious from the equation above that the concentration (N/V) of hydrogen molecules near the adsorbent is proportional to exp(−Δμ/kT); therefore, the smaller the Δμ, the higher the concentration of hydrogen molecules. It follows that an adsorbent with a small value of Δμ has more chances to catch hydrogen molecules thereon or therein. Theoretically, the smaller the value of Δμ, the better the ability to adsorb hydrogen molecules.

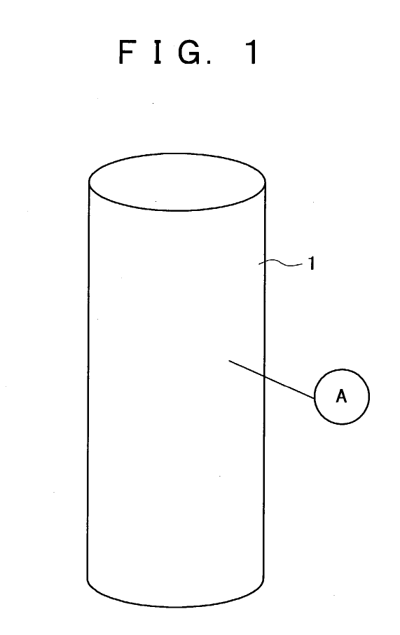

FIG. 1 is a conceptual diagram showing a carbonaceous material in Example 1 of the present invention. This carbonaceous material is a carbon nanotube derivative consisting of a carbon nanotube 1 and atoms or atomic groups A added thereto.

The results of the present inventors' investigation revealed that the carbon nanotube derivative shown in FIG. 1 makes hydrogen molecules in the vicinity thereof change in the chemical potential Δμ according to the species of the atoms or atomic groups A added thereto, as shown in Table 1 below.

TABLE 1

| Atom or Atomic Group A | Δ μ (meV) |
|---|---|
| None | −5.0 |
| Hydroxyl Group | −5.1 |
| Aldehyde Group | −5.2 |
| Cyano Group | −4.8 |
| Sodium Atom | −7.2 |
| Hydrogen Atom | −6.3 |
| Fluorine Atom | −8.1 |

It is apparent from Table 1 that the chemical potential Δμ of hydrogen molecules remains almost unchanged in the case of the carbon nanotube derivative having aldehyde groups, cyano groups, or hydroxyl groups added thereto, whereas the chemical potential Δμ of hydrogen molecules is lower than that of a pure carbon nanotube in the case of the carbon nanotube derivative having hydrogen atoms, sodium atoms, or fluorine atoms added thereto. It is known that the carbon nanotube derivative having fluorine atoms added thereto makes the chemical potential of hydrogen molecules decrease appreciably. This suggests that the carbon nanotube derivative has a much larger hydrogen occluding capacity than a pure carbon nanotube.

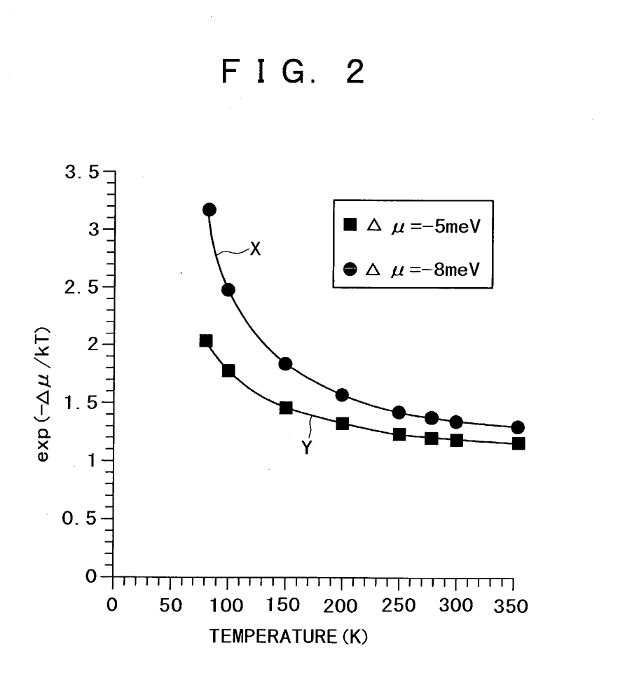

FIG. 2 is a graph showing the relation between exp(−Δμ/kT) and temperature (K). The curve X represents the carbon nanotube derivative having fluorine atoms added to a pure carbon nanotube, and the curve Y represents a pure carbon nanotube.

It is noted from FIG. 2 that the compression ratio increases about three times at 80K in the case of the carbon nanotube derivative having fluorine atoms added to a pure carbon nanotube. The decreased chemical potential Δμ of hydrogen molecules results in a higher concentration of hydrogen molecules at a thermal equilibrium in the vicinity of the carbon nanotube derivative. The result under normal pressure is identical with that under pressure. This leads to an increased hydrogen-occluding capacity.

### EXAMPLE 2

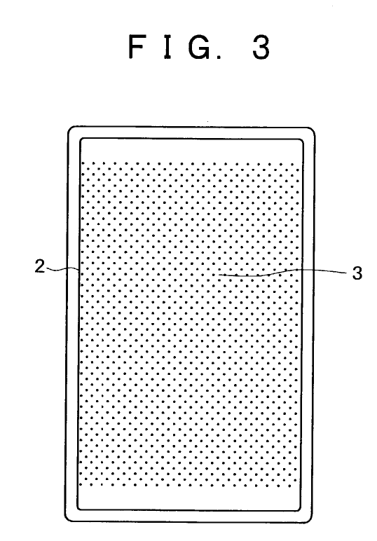

This example is concerned with a hydrogen-occluding apparatus, which, as shown in FIG. 3, consists of a pressure container 2. A carbon nanotube derivative 3 as a hydrogen-occluding material, composed of a pure carbon nanotube and fluorine atoms as atoms A added thereto is held in the pressure container 2.

This hydrogen-occluding apparatus is capable of occluding a large amount of hydrogen because the chemical potential Δμ of hydrogen molecules of the carbon nanotube derivative is much lower than that of the pure carbon nanotube, thereby increasing the concentration of hydrogen molecules in thermal equilibrium in the vicinity of the carbon nanotube derivative.

### EXAMPLE 3

This example is intended to improve the hydrogen adsorbing capacity by modifying the carbon nanotube derivative 3 used in Example 2 which is fluorinated carbon nanotube formed by adding fluorine atoms to a carbon nanotube. The one used in this example is a fluorocarbon single-wall nanotube (F-SWNT) in which fluorine atoms are added to regions with specific shape and arrangement.

A F-SWNT is obtained by annealing single-wall nanotube in fluorine gas. A pure F-SWNT (CFₓ, where x=0.1 to 1.0) is obtained by adequate pretreatment and heating, as reported in the following literature:

A. Hamwi, H. Alvergnat, S. Bonnamy, F. Beguin, Carbon, vol. 35 (1997), No. 6,723; and

E. T. Mickelson, C. B. Huffman, A. G. Rinzler, R. E. Smalley, R. H. Hauge, J. L. Margrave, Chem. Phys. Lett. vol. 296 (1998), 188.

According to the second literature given above, F-SWNT is obtained by reacting 150 to 200 μg of SWNT in a mixed gas of fluorine (F₂) and helium (He) under normal pressure at 150 to 600° C. for 5 hours, with the flow rate of fluorine and helium being 2 sccm and 20 sccm, respectively. The amount of fluorine adsorbed increases as the reaction temperature increases. For example, C:F≈1:0.1 at 150° C. and C:F≈1:0.6 at 400° C. The stable structure of F-SWNT (CFₓ, x=0.5) having the chiral vector of (10,10) and (18,0) has been elucidated by calculating the total energy on the basis of gaussian distribution (K. N. Kudin, H. F. Bettinger, G. E. Scuseria, Phys. Rev. B63 (2001), 04513). However, nothing has been reported about the analysis of hydrogen adsorption energy of F-SWNT, as far as the present inventors know. The present inventors analyzed by first-principle calculation the adsorption energy of hydrogen molecules at a plurality of sites in F-SWNT (12,0) represented by CFₓ (x=0.25 and 0.125). The results were compared with those of SWNT (12,0) of the same type. Hydrogen Adsorption Energy of SWNT (12,0)

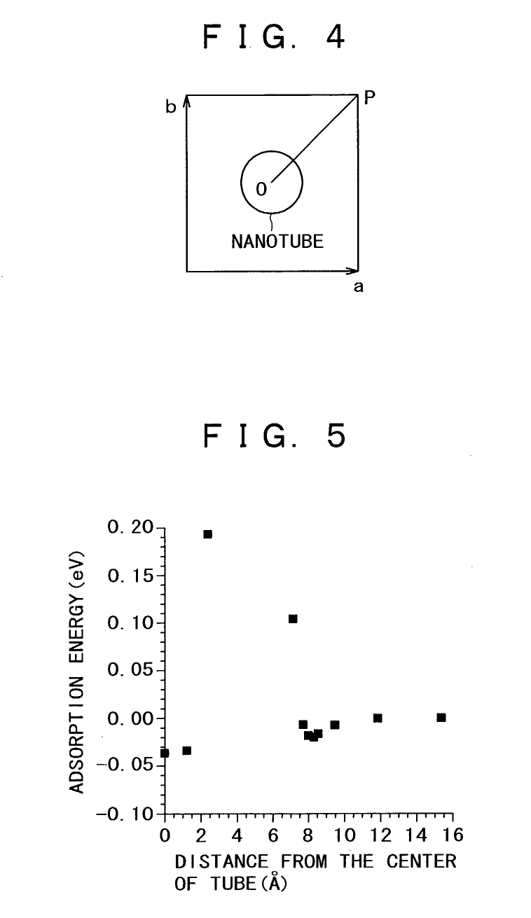

The adsorption energy of hydrogen molecules was calculated by using the ultrasoft pseudopotential (USPP) program VASP (G. Kresse and J. Furthmuller, Phys. Rev. B56 (1996), 111691), and the generalized gradient approximation (GGA) potential was used as the exchange-correlation potential (J. P. Perdew and Y. Wang, Phys. Rev. B45 (1992), 13244). A model shown in FIG. 4 was used to calculate the relation between the position and the adsorption energy of a hydrogen molecule. According to the USPP method, this model regards the SWNT as being infinitely long in the c-axis direction because periodic boundary conditions are given to the wave function at the cell boundary. It was assumed that the length of the c-axis is 8.53 Å, which is twice as long as the unit cell, so as to avoid the influence of hydrogen molecules in the adjoining cells. Calculations were carried on the assumption that the cutoff energy is 350 eV and the K point is (1×1×4). First, the most stable structure (including the c-axis length) and the total energy of SWNT were calculated. Then, with a hydrogen molecule arranged on the line OP in FIG. 4 and restrained in the directions of a and b, the most stable structure as a whole was calculated. The difference between the total energy thus obtained and the total energy of the tube and hydrogen molecule was regarded as the adsorption energy. The results are shown in FIG. 5. It is noted from FIG. 5 that there are regions on the inside and outside of the tube where the mutual action (adsorption energy) is negative or the adsorbing action exists. The minimum value of the adsorption energy was −37 meV (inside) and −20 meV (outside). Hydrogen Adsorption Energy of F-SWNT (12,0) CFₓ (x=0.25)

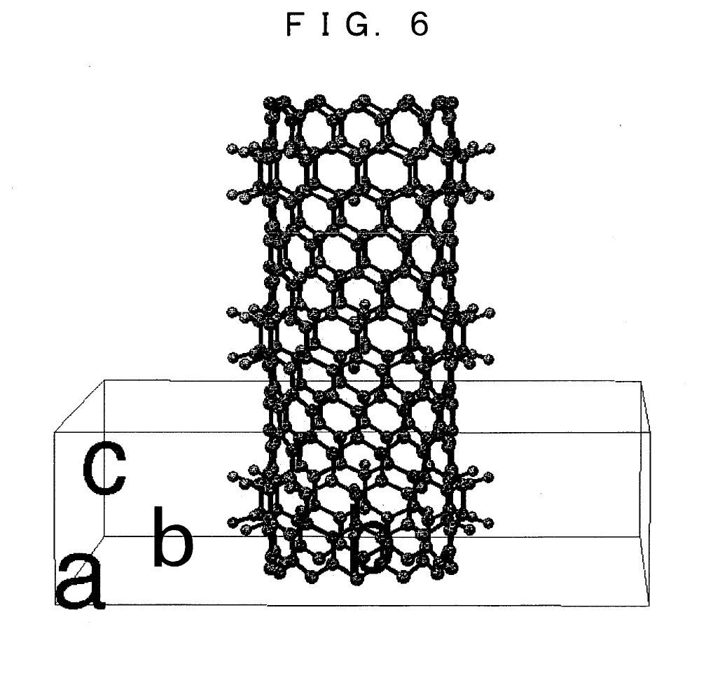

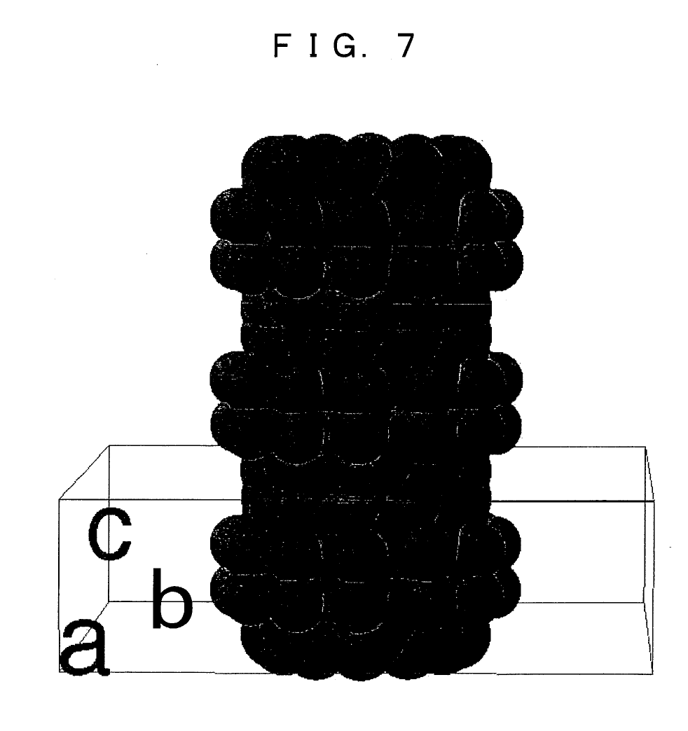

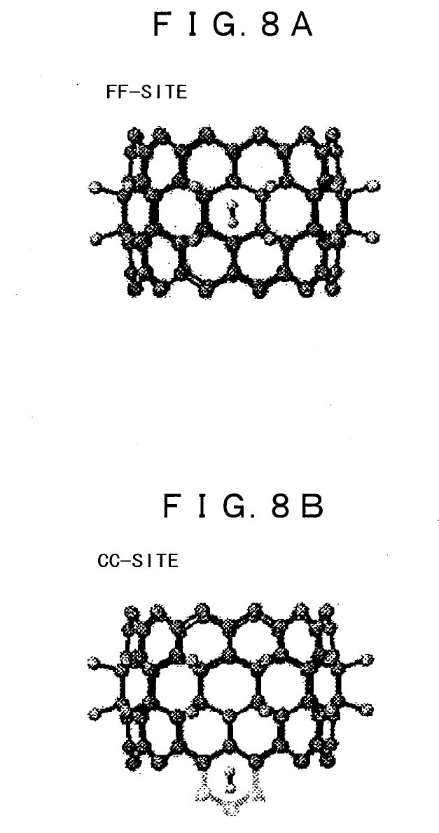

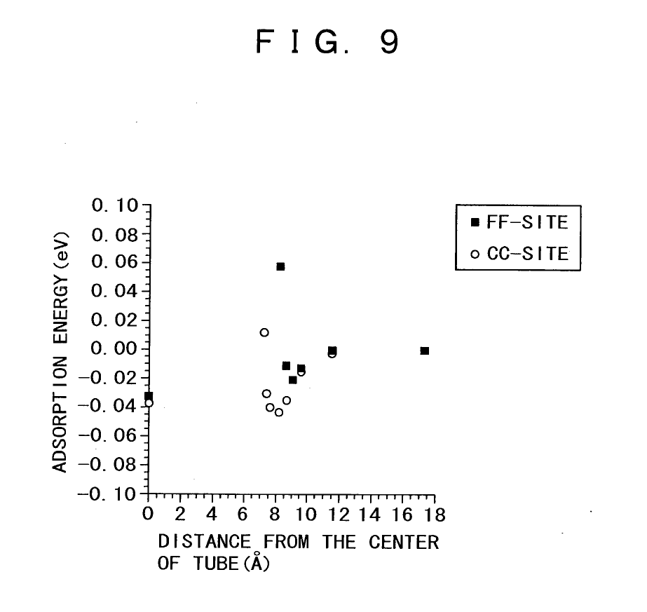

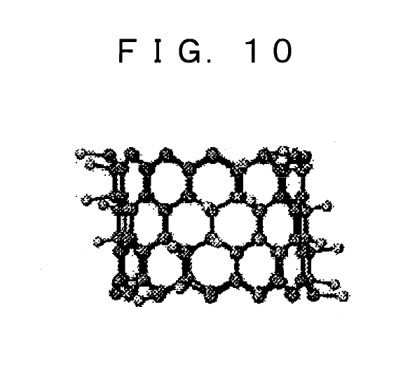

It was assumed that fluorine atoms are arranged in a strip pattern in a cylindrical structure of the tube as shown in FIG. 6 (ball-and-stick model) and FIG. 7 (space-filling model). Hereinafter, white circles represent fluorine atoms and black circles represent carbon atoms. As in the case of the SWNT (12,0), it was assumed that the length of the c-axis is 8.42 Å, which is twice as long as the unit cell of the SWNT so as to avoid the influence of hydrogen molecules in the adjoining cells and the K point is (1×1×4). It was assumed that the cutoff energy is 425 eV in view of the fact that a fluorine atom has a large radius of electron orbital. First, the most stable structure (including the c-axis length) and the total energy of the SWNT were calculated. Then, with a hydrogen molecule arranged on the line OP in FIG. 4 and restrained in the directions of a and b, the most stable structure as a whole was calculated. The difference between the total energy thus obtained and the total energy of the tube and hydrogen molecule was regarded as the adsorption energy. Calculations were carried out by assuming two kinds of hydrogen molecule adsorbing sites, as shown in FIG. 8A (FF-site passing through a 6-membered ring near fluorine atoms) and in FIG. 8B (CC-site passing through a 6-membered ring farthest away from fluorine atoms). The results are shown in FIG. 9. It is noted from FIG. 9 that there are regions on the inside and outside of the tube where the mutual action (adsorption energy) is negative or the adsorbing action exists. The minimum value of the adsorption energy at CC-site is smaller than that at FF-site. In other words, the adsorption energy at FF-site was −31 meV (inside the tube) and −20 meV (outside the tube), whereas the adsorption energy at CC-site was −37 meV (inside the tube) and −43 meV (outside the tube). This suggests that the adsorbing action outside the tube at the CC-site is more than twice as strong as that of the SWNT (12,0). The present inventors are the first to find this fact.

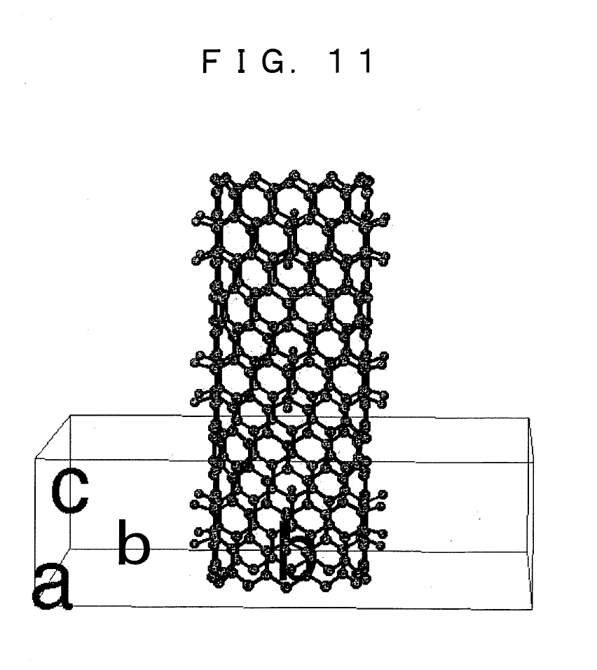

Arrangements of fluorine atoms on the SWNT may be possible in various patterns as reported in the above-mentioned literature (K. N. Kudin, H. F. Bettinger, G. E. Scuseria, Phys. Rev. B63 (2001), 045413). The pattern may be different from an arrangement which is experimentally obtained because there would be a difference in heat of formation. FIG. 10 shows one possible model for zigzag arrangement. This model is similar to that in FIG. 6 in the overall electron state and the local electron state near the C—F bond. Therefore, it is expected that both models give the same results for adsorption energy. Hydrogen Adsorption Energy of F-SWNT (12,0) CFₓ (x=0.125)

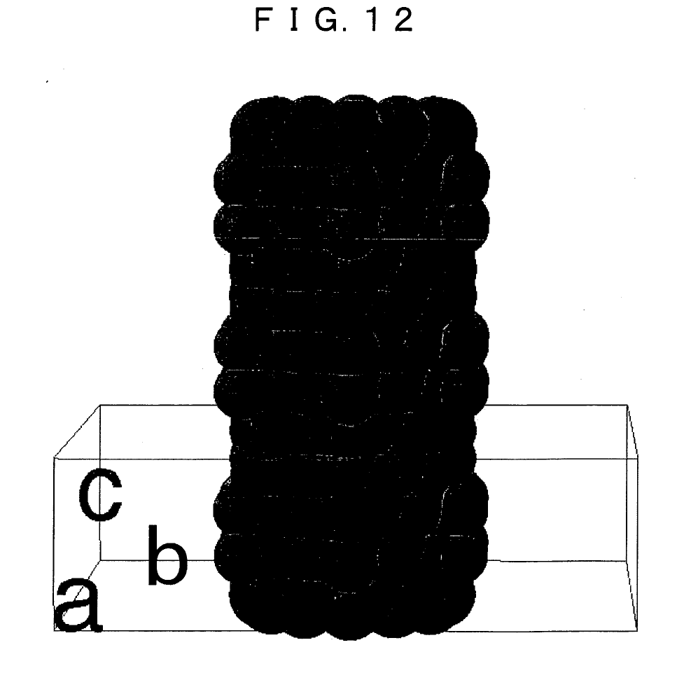

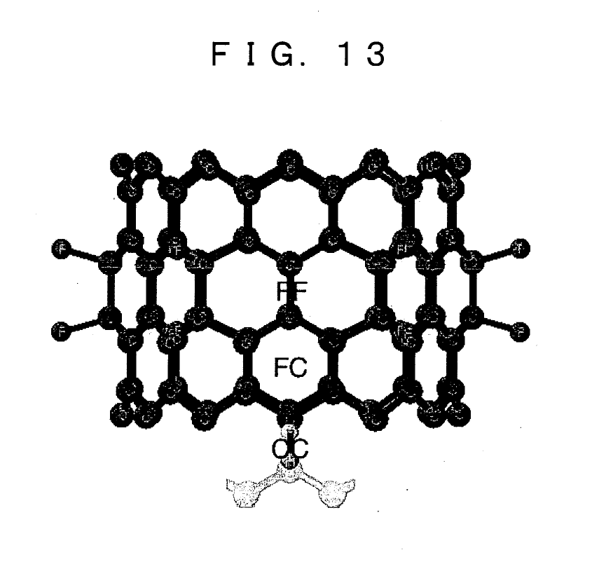

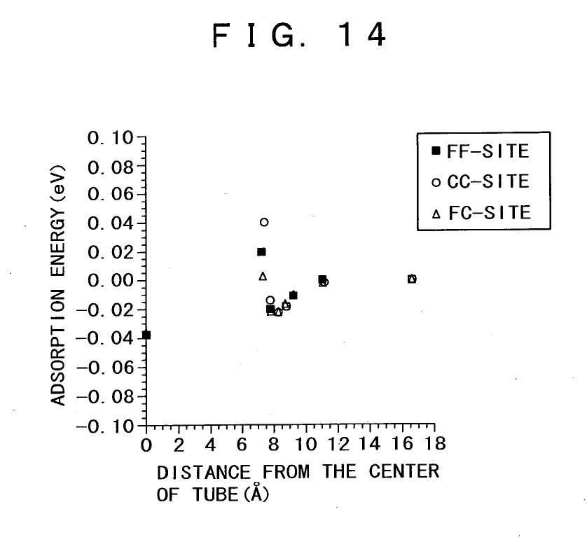

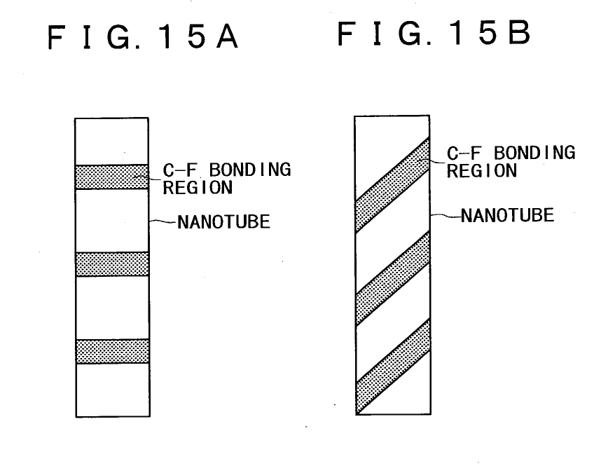

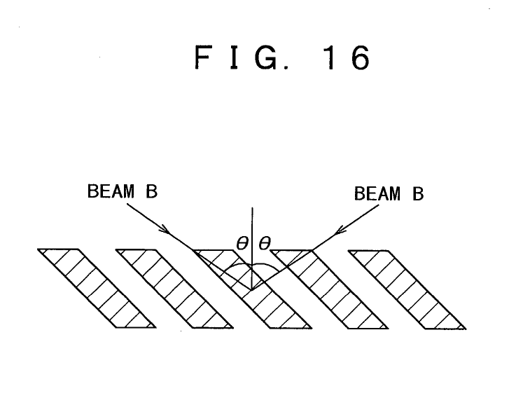

It was assumed that fluorine atoms are arranged in a strip pattern in a cylindrical structure of the tube as shown in FIG. 11 (ball-and-stick model) and FIG. 12 (space-filling model). It was also assumed that the length of the c-axis is 8.53 Å, which is twice as long as the unit cell of the SWNT, the K point is (1×1×4), and the cutoff energy is 425 eV, as is the case with the SWNT (12,0) CFₓ (x=0.25). Calculations were carried out for three kinds hydrogen adsorption sites as shown in FIG. 13, FF-site near fluorine atoms, CC-site farthest away from fluorine atoms, and FC-site an intermediate distance away from fluorine atoms. The results are shown in FIG. 14. It is noted from FIG. 14 that the adsorption energy is almost equal at the three sites, that is, about −37 meV inside the tube and about −21 meV outside the tube. These values are equivalent of those of the SWNT (12,0). CFₓ (x=0.125) differs from CFₓ (x=0.25) in electron state such that one conjugated system covers the entire tube in the former and the conjugated system is divided into several pieces by the sp³ orbital due to C—F bonding. If this is an important factor for the adsorption energy, it would be possible to improve the adsorption energy by means of the structure which is formed when the tube surface is divided into several regions by C—F bonds taking on strip shapes arranged at adequate intervals as shown in FIGS. 6 and 10. On the other hand, since the effective adsorption site for hydrogen molecules is the one which has no C—F bond, it is desirable that the value of x should be small. This is illustrated in FIGS. 15A and 15B. It is to be noted that the cylindrical surface of a nanotube is divided by the continuous C—F bonding regions, and the continuous conjugated system is divided into strip-like regions. These structures have never been reported before. The strip-like conjugated system is found also in conductive polymers. The fact that polypyrrole and polythiophene have a comparatively high hydrogen adsorbing energy backs up the foregoing hypothesis.

The F-SWNT having fluorine atoms arranged in a strip pattern can be produced in the following manner.

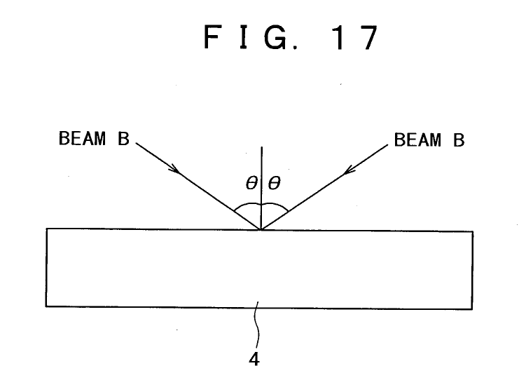

An interference pattern with a periodically changing intensity can be obtained by irradiating a substrate (not shown) with a beam B, such as laser beam (with a UV wavelength), electron beam, and X-ray beam, which is subject to interference, as shown in FIG. 16. The resulting interference fringes have a cycle Λ defined by Λ=λA/2 sin θ(where θ is the incident angle of the beam B with respect to the substrate and λ is the wavelength of the beam B. Therefore, as the incident angle θ changes, the cycle of the interference fringes changes in the range of λ/2 to infinity.

According to a first method, as shown in FIG. 17, a SWNT 4 is placed in a fluorine-containing gaseous atmosphere, so that fluorine bonds to the surface of the SWNT 4. Then, the SWNT 4 is irradiated with a beam B (radiating along a plane containing the axis of the SWNT 4) which has an energy larger than the bonding energy of fluorine, so that interference fringes occur in the direction perpendicular to the axis of the SWNT 4. Fluorine atoms release themselves from the surface of the SWNT 4 at the part where the interference fringe has a high intensity. As the result, fluorine atoms remain in a strip pattern.

According to a second method, a SWNT 4 is placed in a fluorine-containing gaseous atmosphere, and the SWNT 4 is irradiated with a beam B (radiating along a plane containing the axis of the SWNT 4) which has an energy larger than the bonding energy of fluorine, so that interference fringes occur in the direction perpendicular to the axis of the SWNT 4. Thus, fluorine atoms bond to the surface of the SWNT 4 at the part where the interference fringe has a high intensity. As the result, fluorine atoms bond in a strip pattern.

Having described specific examples of the present invention, it is to be understood that the invention is not limited to them and various changes and modifications may be made in the invention without departing from the spirit and scope thereof.

The values, materials, structures, shapes, processes, etc. mentioned in the foregoing examples are provided by way of illustration only; therefore, they may be changed according to need.

For example, it is not always necessary in Example 2 to fill the pressure container 2 with the carbon nanotube derivative 3 which is formed by adding fluorine atoms to a pure carbon nanotube. The carbon nanotube derivative 3 may be replaced by any cylindrical carbonaceous molecule which has atoms or atomic groups introduced thereinto, so long as the atoms or atomic groups are one or more species selected from the group consisting of fluorine atoms, hydrogen atoms, or sodium atoms, and the atoms or atomic groups are present in the vicinity of a carbonaceous material of conjugated system into which the atoms or atomic groups are not introduced. Moreover, the atoms or atomic groups are introduced such that their chemical potential is lower than that of hydrogen molecules equivalent thereto. It is not always necessary that such atoms or atomic groups are fluorine atoms, hydrogen atoms, or sodium atoms.

As mentioned above, the present invention provides a carbonaceous material which has such a greatly improved hydrogen-adsorbing capacity that it can occlude a large amount of hydrogen even under normal pressure. This carbonaceous material is practically useful for high-performance hydrogen-occluding materials, hydrogen-occluding apparatus, and fuel cells.

What is claimed is:

1. A carbonaceous material comprising a cylindrical carbonaceous molecule; and
an atom or atomic group introduced thereinto, wherein a chemical potential of a hydrogen molecule near said cylindrical carbonaceous molecule introduced said atom or atomic group thereinto is lower than a chemical potential of another hydrogen molecule near a cylindrical carbonaceous molecule which is not introduced said atom or atomic group thereinto, the position of said another hydrogen molecule being equivalent to that of said a hydrogen molecule to said cylindrical carbonaceous molecule.

2. The carbonaceous material as defined in claim 1, wherein the cylindrical carbonaceous molecule is a carbon nanotube.

3. The carbonaceous material as defined in claim 1, wherein the atom or atomic group comprises one or more species selected from the group consisting of a fluorine atom, a hydrogen atom, and a sodium atom.

4. The carbonaceous material as defined in claim 1, wherein the atom or atomic group comprises atoms or atomic groups, and the atoms or atomic groups are introduced partly to the surface of the cylindrical carbonaceous molecule.

5. The carbonaceous material as defined in claim 1, wherein the atom or atomic group comprises atoms or atomic groups, and the cylindrical carbonaceous molecule has the surface such that the region in which the atoms or atomic groups are not introduced is divided into a plurality of regions by the region into which the atoms or atomic groups are introduced.

6. The carbonaceous material as defined in claim 1, wherein the atom or atomic group comprises atoms or atomic groups, and the atoms or atomic groups are introduced into the surface of the cylindrical carbonaceous molecule in a strip pattern.

7. The carbonaceous material as defined in claim 6, wherein the region into which the atoms or atomic groups are introduced in a strip pattern has a cylindrical structure or spiral structure.

8. A hydrogen-occluding material containing a carbonaceous material, said carbonaceous material comprising a cylindrical carbonaceous molecule; and an atom or atomic group introduced thereinto, wherein a chemical potential of a hydrogen molecule near said cylindrical carbonaceous molecule introduced said atom or atomic group thereinto is lower than a chemical potential of another hydrogen molecule near a cylindrical carbonaceous molecule which is not introduced said atom or atomic group thereinto, the position of said another hydrogen molecule being equivalent to that of said a hydrogen molecule to said cylindrical carbonaceous molecule.

9. A hydrogen-occluding apparatus having a pressure container and a hydrogen-occluding material held therein, said hydrogen-occluding material containing a carbonaceous material, said carbonaceous material comprising a cylindrical carbonaceous molecule; and an atom or atomic group introduced thereinto, wherein a chemical potential of a hydrogen molecule near said cylindrical carbonaceous molecule introduced said atom or atomic group thereinto is lower than a chemical potential of another hydrogen molecule near a cylindrical carbonaceous molecule which is not introduced said atom or atomic group thereinto, the position of said another hydrogen molecule being equivalent to that of said a hydrogen molecule to said cylindrical carbonaceous molecule.

10. A fuel cell which employs a hydrogen-occluding material, said hydrogen-occluding material containing a carbonaceous material, said carbonaceous material comprising a cylindrical carbonaceous molecule; and an atom or atomic group introduced thereinto, wherein a chemical potential of a hydrogen molecule near said cylindrical carbonaceous molecule introduced said atom or atomic group thereinto is lower than a chemical potential of another hydrogen molecule near a cylindrical carbonaceous molecule which is not introduced said atom or atomic group thereinto, the position of said another hydrogen molecule being equivalent to that of said a hydrogen molecule to said cylindrical carbonaceous molecule.

11. A hydrogen-occluding material comprising a cylindrical carbonaceous molecule into which at least one fluorine atom is introduced.

12. The hydrogen-occluding material as defined in claim 11, wherein the cylindrical carbonaceous molecule is a carbon nanotube.

13. The hydrogen-occluding material as defined in claim 11, wherein the fluorine atom comprises fluorine atoms, and the fluorine atoms are introduced partly to the surface of the cylindrical carbonaceous molecule.

14. The hydrogen-occluding material as defined in claim 11, wherein the fluorine atom comprises fluorine atoms, and the cylindrical carbonaceous molecule has the surface such that the region in which the fluorine atoms are not introduced is divided into a plurality of regions by the region into which the fluorine atoms are introduced.

15. The hydrogen-occluding material as defined in claim 11, wherein the fluorine atom comprises fluorine atoms, and the fluorine atoms are introduced into the surface of the cylindrical carbonaceous molecule in a strip pattern.

16. The hydrogen-occluding material as defined in claim 15, wherein the region into which the fluorine atoms are introduced in a strip pattern a cylindrical structure or spiral structure.

17. A hydrogen-occluding apparatus having a pressure container and a hydrogen-occluding material held therein, said hydrogen-occluding material containing a cylindrical carbonaceous molecule having at least one fluorine atom introduced thereinto.

18. A fuel cell which employs a hydrogen-occluding material, said hydrogen-occluding material containing a cylindrical carbonaceous molecule having at least one fluorine atom introduced thereinto.

19. A method of hydrogen occlusion, comprising the steps of:
supplying hydrogen to a carbonaceous material containing a cylindrical carbonaceous molecule having at least one fluorine atom introduced thereinto; and
changing pressure and/or temperature.
